(19) United States
(12) Patent Application Publication
(10) Pub. No.: US 2025/0164791 A1
(43) Pub. Date: May 22, 2025

(54) NEAR-FOCUS OPTICAL SYSTEM WITH MULTI-FOCAL CORRECTION

(71) Applicant: Vuzix Corporation, West Henrietta, NY (US)

(72) Inventors: Robert J. Schultz, Victor, NY (US); Robert W. Gray, Rochester, NY (US)

(21) Appl. No.: 18/839,435

(22) PCT Filed: Feb. 17, 2023
(86) PCT No.: PCT/US2023/013346

§ 371 Date: Aug. 18, 2024

Related U.S. Application Data
(60) Provisional application No. 63/311,902, filed on Feb. 18, 2022.

(51) Int. Cl. G02B 27/01

(52) U.S. Cl. CPC G02B 27/0172; G02B 2027/0174; G02B 2027/0178

(57) ABSTRACT

An image light guide system that manages focusing discrepancies between real-world and virtual objects presented to the viewer and manages vision problems affecting the focusing capabilities of the particular viewer as well as reducing demands on the viewer's eyes for viewing virtual objects together with real-world objects within the same field of view. The image light guide system includes a negative-power optical element and a positive-power optical element arranged to focus a virtual object at a distance less than optical infinity with respect to an eyebox while ensuring that the focusing distance of real-world objects in the same field of view remain unchanged. The image light guide system also includes one or more optical elements that provide one or more corrective optical contributions to correct for the viewer's specific optical aberrations.

### TECHNICAL FIELD

The present disclosure generally relates to augmented reality systems that include near-eye displays operable to display virtual images superimposed on real-world views through the displays.

### BACKGROUND

Head-mounted displays (HMDs) increasingly take the form of conventional eyeglasses with less obtrusive optics for conveying virtual image content with less obstructed views of the ambient environment. Image generators can be supported along eyeglass temples, and substantially transparent image light guides convey the generated images to the wearer's eye(s) as virtual images that are projected into the wearer's real-world view that is visible through the image light guides.

The virtual image content can be conveyed along the image light guides as a set of angularly related beams, where the relative angular orientation of each beam in two angular dimensions corresponds to a different position (e.g., pixel) within the generated image. Typically, the beams themselves are collimated as if corresponding to a distant point source located at a unique angular position within the field of view. Thus, when the collimated beams are directed into overlapping positions within a common eyebox, the wearer's eye views the generated images from the eyebox as virtual images located at a distance approaching infinity. However, real-world objects of interest to the wearer may be located much closer and require some noticeable eye accommodation to bring into focus. Viewing virtual objects and real-world objects requiring different focusing accommodations within the same scene can cause eye strain.

Vision problems within the wearer's eyes caused by refractive errors such as nearsightedness (myopia), farsightedness (hyperopia), and astigmatism, can also present challenges to low profile HMDs resembling conventional eyeglasses. If a wearer's traditional eyeglasses (containing corrective lenses) must be removed to accommodate a low-profile HMD, the wearer's view of both real-world and virtual objects through the HMDs can be compromised.

### SUMMARY

The present disclosure is directed to one or more exemplary embodiments of an image light guide system that manages focusing discrepancies between real-world and virtual objects presented to the viewer and manages vision problems affecting the focusing capabilities of the particular viewer as well as reducing demands on the viewer's eyes for viewing virtual objects together with real-world objects within the same field of view. The image light guide system includes a negative-power optical element and a positive-power optical element arranged to focus a virtual object at a distance less than optical infinity with respect to an eyebox while ensuring that the focusing distance of real-world objects in the same field of view remain unchanged. The image light guide system also includes one or more optical elements that provide one or more corrective optical contributions to correct for the viewer's specific optical aberrations.

These and other aspects, objects, features, and advantages of the present disclosure will be more clearly understood and appreciated from the following detailed description of the embodiments and appended claims, and by reference to the accompanying drawing figures. In an exemplary embodiment, the present disclosure provides an image light guide system for viewing a virtual object and a real-world object within a common field of view. The image light guide system includes an image light guide having an inner surface and an outer surface, the image light guide arranged to direct image-bearing light beams of the virtual object toward an eyebox for viewing the virtual object at a first focusing distance from the eyebox (e.g., at optical infinity). The image light guide system also includes a negative-power optical element arranged between the image light guide and the eyebox, the negative-power optical element being arranged to diverge the image-bearing light beams in advance of the eyebox for viewing the virtual object at a second focusing distance less than the first focusing distance (e.g., closer than optical infinity). The image light guide system further includes a non-variable corrective optical element and a positive-power optical element. The corrective optical element being arranged between the image light guide and the real-world object, and arranged to reduce a viewer's optical aberrations associated with viewing the real-world object at the second focusing distance; and the positive-power optical element being arranged between the image light guide and the real-world object, wherein the positive-power optical element is configured to compensate for a negative optical power contribution of the negative-power optical element without compensating for a corrective optical contribution of the corrective optical element.

In another exemplary embodiment, the present disclosure provides an image light guide for viewing a virtual object and a real-world object within a common field of view. The image light guide including an inner surface and an outer surface arranged to direct image-bearing light beams of the virtual object toward an eyebox at a first focusing distance. A first metamaterial having a negative optical power contribution configured to diverge the image-bearing light beams in advance of the eyebox at a second focusing distance less than the first focusing distance. A second metamaterial arranged to provide a positive optical power contribution to cancel the negative optical power contribution of the first metamaterial.

### BRIEF DESCRIPTION OF THE DRAWING FIGURES

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a top view of an image light guide with an exaggerated thickness for showing the propagation of light from an image source along the image light guide to an eyebox within which the virtual image can be viewed.

FIG. 2 is a perspective view of an image light guide including an in-coupling diffractive optic, a turning diffractive optic, and out-coupling diffractive optic for managing the propagation of image-bearing light beams.

FIG. 3 is a top plan, schematic view of a portion of an image light guide system according to an exemplary embodiment of the presently disclosed subject matter.

FIG. 4 is a simplified top plan, schematic view of a portion of an image light system showing a common field of view according to an exemplary embodiment of the presently disclosed subject matter.

FIG. 5 is a simplified top plan, schematic view of a portion of an image light system with a negative-power optical element according to an exemplary embodiment of the presently disclosed subject matter.

FIG. 6 is a simplified top plan, schematic view of a portion of an image light system with a negative-power optical element and a positive-power optical element according to an exemplary embodiment of the presently disclosed subject matter.

FIG. 7 is a simplified top plan, schematic view of a portion of an image light system with a negative-power optical element, a positive-power optical element, and a corrective optical element according to an exemplary embodiment of the presently disclosed subject matter.

FIG. 8A is a simplified top plan, schematic view of a portion of an image light system with a negative-power optical element, a positive-power optical element, and a multi-focal corrective optical element according to an exemplary embodiment of the presently disclosed subject matter.

FIG. 8B is a simplified top plan, schematic view of a portion of an image light system with a negative-power optical element, a positive-power optical element, and a multi-focal corrective optical element according to an exemplary embodiment of the presently disclosed subject matter.

FIG. 9 is a simplified top plan, schematic view of a portion of an image light system with a negative-power optical element, a positive-power optical element, and a multi-focal corrective optical element according to an exemplary embodiment of the presently disclosed subject matter.

FIG. 10A is a simplified top plan, schematic view of a portion of an image light system with a multi-function optical element according to an exemplary embodiment of the presently disclosed subject matter.

FIG. 10B is a simplified top plan, schematic view of a portion of an image light system with a multi-function optical element according to another exemplary embodiment of the presently disclosed subject matter.

FIG. 11 is a simplified top plan, schematic view of a portion of an image light system with a multi-function optical element and a lens carrier according to an exemplary embodiment of the presently disclosed subject matter.

FIG. 12 is a simplified top plan, schematic view of a portion of an image light system with first and second metamaterials according to an exemplary embodiment of the presently disclosed subject matter.

FIG. 13 is a perspective view of an image light guide system taking the form of a head-mounted display according to an exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment” or “an embodiment” means that a particular feature, structure, or characteristic described in connection with the embodiment is included in at least one embodiment of the present disclosure. Thus, the appearance of the phrase “in one embodiment” or “in an embodiment” throughout the specification is not necessarily referring to the same embodiment. However, the particular features, structures, or characteristics described may be combined in any suitable manner in one or more embodiments.

Where they are used herein, the terms “first”, “second”, and so on, do not necessarily denote any ordinal, sequential, or priority relation, but are simply used to clearly distinguish one element or set of elements from another, unless specified otherwise.

Where used herein, the term “exemplary” is meant to be “an example of,” and is not intended to suggest any preferred or ideal embodiment.

Where they are used herein, the terms “viewer”, “wearer,” “operator”, “observer”, and “user” are equivalent and refer to the person or machine that wears and views images using an augmented reality system.

Where used herein, the term “coupled” is intended to indicate a physical association, connection, relation, or linking, between two or more components, such that the disposition of one component affects the spatial disposition of a component to which it is coupled. For mechanical coupling, two components need not be in direct contact, but can be linked through one or more intermediary components. A component for optical coupling allows light energy to be input to, or output from, an optical apparatus.

Where used herein, the term “eyebox” is intended to define a two-dimensional area or three-dimensional volume within which an eye, or other optical component, located at any position within the eyebox therein forms one or more focused images.

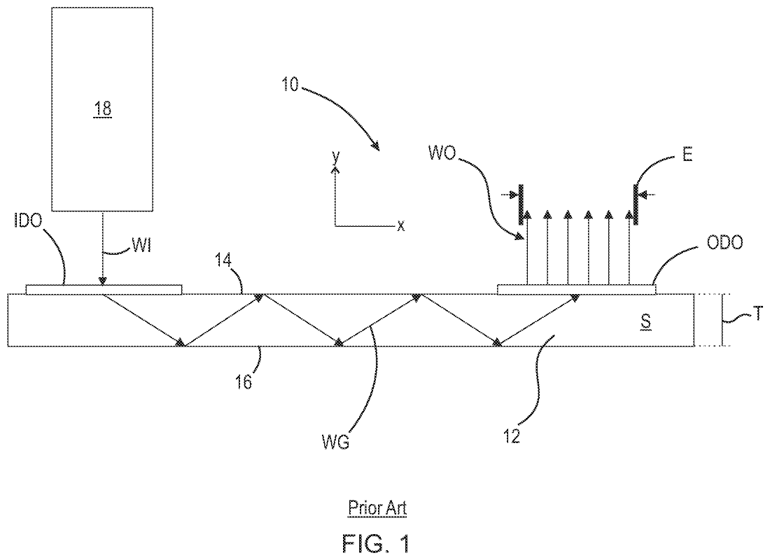

FIG. 1 is a schematic diagram showing a simplified cross-sectional view of one conventional configuration of an image light guide system 10. Image light guide system 10 includes a planar image light guide 12, an in-coupling diffractive optic IDO, and an out-coupling diffractive optic ODO. The image light guide 12 includes a transparent substrate S, which can be made of optical glass or plastic, with plane-parallel front and back surfaces 14 and 16. In this example, the in-coupling diffractive optic IDO is shown as a transmissive-type diffraction grating arranged on the front surface 14 of the image light guide 12. However, in-coupling diffractive optic IDO could alternately be a reflective-type diffraction grating or other type of diffractive optic, such as a volume hologram or other holographic diffraction element, that diffracts incoming image-bearing light beams WI into the image light guide 12. The in-coupling diffractive optic IDO can be located on front surface 14 or back surface 16 of the image light guide 12 and can be of a transmissive or reflective-type in a combination that depends upon the direction from which the image-bearing light beams WI approach the image light guide 12.

When used as a part of a near-eye or head-mounted display system, the in-coupling diffractive optic IDO of the conventional image light guide system 10 couples the image-bearing light beams WI from a real, virtual or hybrid image source 18 into the substrate S of the image light guide 12. Any real image or image dimension formed by the image source 18 is first converted into an array of overlapping, angularly related, collimated beams encoding the different positions within a virtual image for presentation to the in-coupling diffractive optic IDO. Typically, the rays within each bundle forming one of the angularly related beams extend in parallel, but the angularly related beams are relatively inclined to each other through angles that can be defined in two angular dimensions corresponding to linear dimensions of the image.

Once the angularly related beams engage with the in-coupling diffractive optic IDO, at least a portion of the image-bearing light beams WI are diffracted (generally through a first diffraction order) and thereby redirected by in-coupling diffractive optic IDO into the planar image light guide 12 as angularly encoded image-bearing light beams WG for further propagation along a length dimension X of the image light guide 12 by total internal reflection (TIR) between the plane parallel front and back surfaces 14 and 16. Although diffracted into a different combination of angularly related beams in keeping with the boundaries set by TIR, the image-bearing light beams WG preserve the image information in an angularly encoded form that is derivable from the parameters of the in-coupling diffractive optic IDO. The out-coupling diffractive optic ODO receives the encoded image-bearing light beams WG and diffracts (also generally through a first diffraction order) at least a portion of the image-bearing light beams WG out of the image light guide 12, as image-bearing light beams WO, toward a nearby region of space referred to as an eyebox E, within which the transmitted virtual image can be seen by a viewer's eye or other optical component. The out-coupling diffractive optic ODO can be designed symmetrically with respect to the in-coupling diffractive optic IDO to restore the original angular relationships of the image-bearing light beams WI among outputted angularly related beams of the image-bearing light beams WO. In addition, the out-coupling diffractive optic ODO can modify the original field points' positional angular relationships producing an output virtual image at a finite focusing distance.

However, to increase one dimension of overlap among the angularly related beams populating the eyebox E (defining the size of the region within which the virtual image can be seen), the out-coupling diffractive optic ODO is arranged together with a limited thickness T of the image light guide 12 to encounter the image-bearing light beams WG multiple times and to diffract only a portion of the image-bearing light beams WG upon each encounter. The multiple encounters along the length of the out-coupling diffractive optic ODO have the effect of replicating the image-bearing light beams WG and enlarging or expanding at least one dimension of the eyebox E where the replicated beams overlap. The expanded eyebox E decreases sensitivity to the position of a viewer's eye for viewing the virtual image.

The out-coupling diffractive optic ODO is shown as a transmissive-type diffraction grating arranged on or secured to the front surface 14 of the image light guide 12. However, like the in-coupling diffractive optic IDO, the out-coupling diffractive optic ODO can be located on the front or back surface 14 or 16 of the image light guide 12 and can be of a transmissive or reflective-type in a combination that depends upon the direction through which the image-bearing light beams WG is intended to exit the image light guide 12. In addition, the out-coupling diffractive optic ODO could be formed as another type of diffractive optic, such as a volume hologram or other holographic diffraction element, that diffracts propagating image-bearing light beams WG from the image light guide 12 as the image-bearing light beams WO propagating toward the eyebox E.

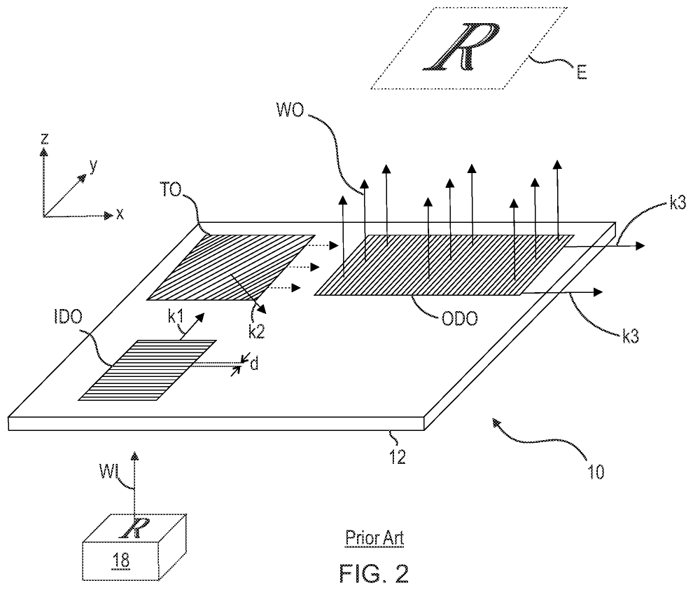

FIG. 2 illustrates a perspective view of a conventional image light guide system 10 arranged for expanding the eyebox E in two dimensions, i.e., along both x- and y-axes of the intended image. To achieve a second dimension of eyebox expansion, the in-coupling diffractive optic IDO is oriented to diffract at least a portion of image-bearing light beams WG about a grating vector k1 along the image light guide 12 toward an intermediate turning optic TO, whose grating vector k2 is oriented to diffract at least a portion of the image-bearing light beams WG in a reflective mode along the image light guide 12 toward the out-coupling diffractive optic ODO. It should be appreciated that only a portion of the image-bearing light beams WG are diffracted by each of the multiple encounters with intermediate turning optic TO, thereby laterally replicating each of the angularly related beams of the image-bearing light beams WG as they approach the out-coupling diffractive optic ODO. The intermediate turning optic TO redirects the image-bearing light beams WG toward the out-coupling diffractive optic ODO (having a grating vector k3) for longitudinally replicating the angularly related beams of the image-bearing light beams WG in a second dimension before exiting the image light guide 12 as the image-bearing light beams WO. Grating vectors, such as the depicted grating vectors k1, k2, and k3, extend within a parallel plane of the image light guide 12 in respective directions that are normal to the diffractive features (e.g., grooves, lines, or rulings) of the diffractive optics and have respective magnitudes inverse to the period or pitch d (i.e., the on-center distance between the diffractive features) of the diffractive optics IDO, TO, and ODO.

As shown in FIG. 2, in-coupling diffractive optic IDO receives the incoming image-bearing light beams WI containing a set of angularly related beams corresponding to individual pixels or equivalent locations within an image generated by the image source 18, such as a projector. A full range of angularly encoded beams for producing a virtual image can be generated by a real display together with collimating optics or other optical components, by a beam scanner for more directly setting the angles of the beams, or by a combination such as a one-dimensional real display used with a scanner. In this configuration, the image light guide 12 outputs a replicated set of angularly related beams (replicated in two dimensions) by providing multiple encounters of the image-bearing light beams WG with both the intermediate turning optic TO and the out-coupling diffractive optic ODO in different orientations. In the depicted orientation of the image light guide 12, the intermediate turning optic TO provides eyebox expansion in the y-axis direction, and the out-coupling diffractive optic ODO provides a similar eyebox expansion in the x-axis direction. The relative orientations and respective periods d of the diffractive features of the in-coupling optic IDO, intermediate turning optic TO, and out-coupling diffractive optic ODO provide for eyebox expansion in two dimensions while preserving the intended relationships among the angularly related beams of the image-bearing light beams WI that are output from the image light guide system 10 as the image-bearing light beams WO. It should be appreciated that the periods d of the in-coupling diffractive optic IDO, the intermediate turning optic TO, and the out-coupling diffractive optic ODO, can each include diffractive features having a common pitch d, where the common pitch d of each optic can be different.

In the configuration shown, while the image-bearing light beams WI input into the image light guide 12 are encoded into a different set of angularly related beams by the in-coupling diffractive optic IDO, the information required to reconstruct the image is preserved by accounting for the systematic effects of the in-coupling diffractive optic IDO. The intermediate turning optic TO, located in an intermediate position between the in-coupling and out-coupling diffractive optics IDO and ODO, can be arranged so that it does not induce significant changes to the encoding of the image-bearing light beams WG. As such, the out-coupling diffractive optic ODO can be arranged in a symmetric fashion with respect to the in-coupling diffractive optic IDO, e.g., including diffractive features sharing the same period d. Similarly, the period of the intermediate turning optic TO can also match the common period of the in-coupling and out-coupling diffractive optics IDO and ODO. Although the grating vector k2 of the intermediate turning optic TO is shown oriented at 45 degrees with respect to the other grating vectors, which remains a possible orientation, the grating vector k2 of the intermediate turning optic TO can be oriented at 60 degrees to the grating vectors k1 and k3 of the in-coupling and out-coupling diffractive optics IDO and ODO in such a way that the image-bearing light beams WG is turned 120 degrees. By orienting the grating vector k2 of the intermediate turning optic TO at 60 degrees with respect to the grating vectors k1 and k3 of the in-coupling and out-coupling diffractive optics IDO and ODO, the grating vectors k1 and k3 of the in-coupling and out-coupling diffractive optics IDO and ODO are also oriented at 60 degrees with respect to each other. By basing the grating vector magnitudes on the common pitch shared by the in-coupling, intermediate turning, and out-coupling diffractive optics IDO, TO, and ODO, the three grating vectors k1, k2, and k3 (as directed line segments) form an equilateral triangle and sum to a zero vector magnitude, which avoids asymmetric effects that could introduce unwanted aberrations including chromatic dispersion. Such asymmetric effects can also be avoided by grating vectors k1, k2, and k3 that have unequal magnitudes in relative orientations at which the three grating vectors k1, k2, and k3 sum to a zero vector magnitude.

In a broader sense, the image-bearing light beams WI that are directed into the image light guide 12 are effectively encoded by the in-coupling diffractive optic IDO, whether the in-coupling optic IDO uses gratings, holograms, prisms, mirrors, or some other mechanism. Any reflection, refraction, and/or diffraction of light that takes place at the input should be correspondingly decoded by the output to re-form the virtual image that is presented to the viewer. Whether any symmetries are maintained among the intermediate turning optic TO, the in-coupling optic IDO, and out-coupling diffractive optic ODO, or whether any change to the encoding of the angularly related beams of the image-bearing light beams WI takes place along the image light guide 12, the intermediate turning optic TO and the in-coupling and out-coupling diffractive optics IDO and ODO can be related so that the image-bearing light beams WO that are output from the image light guide 12 preserve or otherwise maintain the original or desired form of the image-bearing light beams WI for producing the intended virtual image.

As shown in FIG. 2, the letter “R” represents the orientation of the virtual image that is visible to the viewer whose eye is positioned within the eyebox E. As shown, the orientation of the letter “R” in the represented virtual image matches the orientation of the letter “R” as encoded by the image-bearing light beams WI. A change in the rotation about the z axis or angular orientation of incoming image-bearing light beams WI with respect to the x-y plane causes a corresponding symmetric change in rotation or angular orientation of outgoing light from out-coupling diffractive optic (ODO). From the aspect of image orientation, the intermediate turning optic TO simply acts as a type of optical relay, providing expansion of the angularly encoded beams of the image-bearing light beams WG along one axis (e.g., along the y axis) of the image. Out-coupling diffractive optic ODO further expands the eyebox along another axis (e.g., along the x-axis) while maintaining the original orientation of the virtual image encoded by the image-bearing light beams WI. The intermediate turning optic TO is typically a slanted or square grating or, alternately, can be a blazed grating and is typically arranged on one of the plane parallel front and back surfaces of the image light guide 12. It should be appreciated that the representation of the virtual image “R” as created by an image source is comprised of infinitely focused light that requires a lens (e.g., the lens in the human eye) to focus the image so that the orientations discussed above can be detected.

Together, the in-coupling, turning, and out-coupling diffractive optics IDO, TO, and ODO preferably preserve the angular relationships among beams of different wavelengths defining a virtual image upon conveyance by image light guide 12 from an offset position to a near-eye position of the viewer. While doing so, the in-coupling, turning, and out-coupling diffractive optics IDO, TO, and ODO can be relatively positioned and oriented in different ways to control the overall shape of the image light guide 12 as well as the overall orientations at which the angularly related beams can be directed into and out of the image light guide 12.

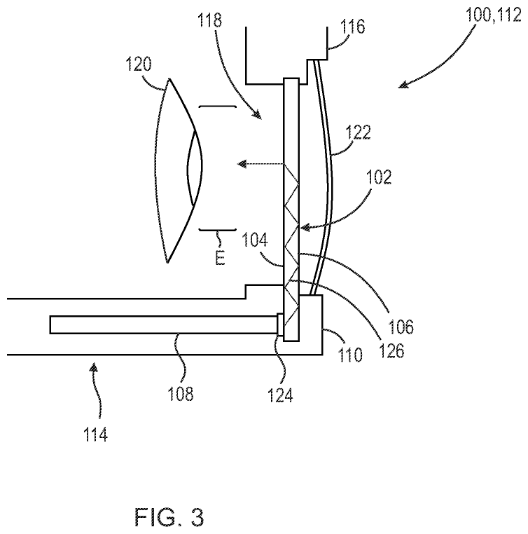

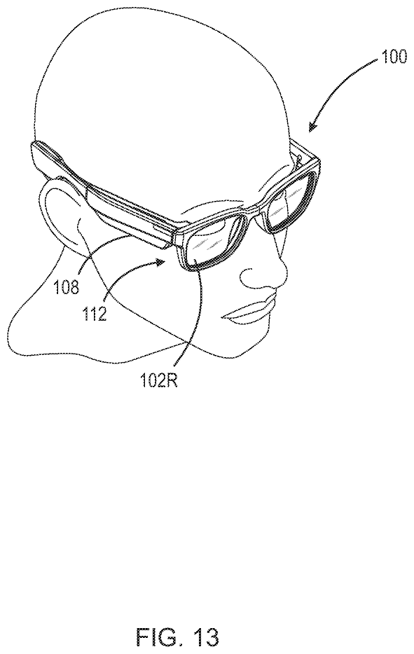

FIG. 3 shows a top plan, schematic view of a portion of an exemplary head-mounted image light guide system 100 according to the present disclosure. In some examples, image light guide system 100 can take the form of a head-mounted display (shown in FIG. 13) or other head-mounted optical system. As shown in FIG. 3, the example image light guide system 100 includes an image light guide 102 in the form of a planar waveguide. Although not shown, image light guide 102 can include the same structure, functionality, material, and/or features described above with respect to image light guide 12, e.g., image light guide 102 can include an in-coupling diffractive optic, an intermediate turning optic, and an out-coupling diffractive optic. Although illustrated as a planar waveguide, it should be appreciated that image light guide 102 can be a non-planar waveguide, e.g., a curved waveguide. Additionally, the image light guide 102 includes a transparent substrate, which can be made of, without limitation, optical glass or plastic, with plane-parallel front and back surfaces 104 and 106, respectively. It should be appreciated that, similarly to image light guide system 10 described above, image light guide system 100 and image light guide 102 are configured to receive angularly related image-bearing light beams and couple the angularly related image-bearing light beams into the image light guide 102 by an in-coupling diffractive optic (located on the front or back surfaces 104, 106 of the image light guide and configured as transmissive-type or reflective-type diffraction element). Once coupled into image light guide 102, the angularly encoded image-bearing light beams are configured to propagate along a length dimension of the image light guide 102 and exit the image light guide 102 by interaction with an out-coupling diffractive optic, such that at least one image is formed within an eyebox E for viewing by a viewer or other optical component. As described above with respect to image light guide 12, image light guide 102 can also utilize one or more encounters with an intermediate turning optic or the out-coupling optic to expand the size of the eyebox E in one or more dimensions.

As shown in FIG. 3, image light guide system 100 also includes an image source 108. In some examples, image source 108 is a projector that includes a light source as well as one or more optical components to focus and/or collimate light generated by the light source. In some examples, image source 108 comprises one or more light-emitting diodes (LEDs), organic LEDs (OLEDs), or ultra LEDs (uLEDs). In other examples, image source 108 is a color field sequential projector system operable to pulse image-bearing light of multiple wavebands, for example light from within red, green, and blue wavelength ranges, onto a digital light modulator/micro-mirror array (a “DLP”) or a liquid crystal on silicon (“LCOS”) display. In further examples, image source 108 includes one or more pico-projectors, where each pico-projector is configured to produce a single primary color band (e.g., red, green, or blue). In another example, image source 108 includes a single pico-projector arranged to produce at least three primary color bands (e.g., red, green, and blue). In one example, the three primary color bands include a green band having a wavelength in the range between 495 nm and 570 nm, a red band having a wavelength in the range between 620 nm and 750 nm, and a blue band having a wavelength in the range between 450 nm and 495 nm. The substantially collimated light generated by the pico-projector, once coupled and transmitted through image light guide 102, can be used by image light guide system 100 to form one or more virtual images viewable by a user's eye or other optical components positioned within eyebox E.

With continued reference to FIG. 3, image light guide system 100 also includes a frame 110 which includes a right eye-rim section 112 having a right temple 114 and a nose-bridge portion 116. Between temple 114 and nose-bridge portion 116, frame 110 includes a right aperture 118 configured to receive image light guide 102 such that during operation of the image light guide system 100, the image light guide 102 is configured to form at least one image related to one or more virtual objects within a viewer's right eye 120. Although only the right eye-rim section 112 and right eye 120 are illustrated in FIG. 3, it should be appreciated that frame 110 can be symmetrical, i.e., can include a right eye-rim section 112 and left eye-rim section (not shown) where each of the right eye-rim section 112 and the left eye-rim section both include a respective temple and respective image light guides 102 configured to form respective virtual images related to one or more virtual objects within the viewer's right and left eyes. In other words, image light guide system 100 and frame 110 can be configured as a binocular display system forming images in both the right and left eye of the viewer. In some examples, frame 110 is made of a metal, plastic, or wood material (or any combination thereof), and is intended to be opaque, i.e., not transmissive to visible light. In some examples, image light guide 102 is removably secured between the temple 114 and nose-bridge portion 116, i.e., image light guide 102 can be removed and/or replaced without the aid of additional tools. Further, it should be appreciated that in one or more exemplary embodiments of image light guide system 100 (whether a binocular system as described above or a monocular system), the image light guide system 100 can include multiple, stacked, image light guides 102. For example, one image light guide 102 of the stack is configured to in-couple and propagate light of a first wavelength range (e.g., light in the red portion of the visible spectrum), while another image light guide 102 of the stack is configured to in-couple and propagate a second wavelength range (e.g., light in the green and/or blue portions of the visible spectrum).

Additionally, as shown in FIG. 3, image light guide system 100 can further include a cover window or other protective outer cover 122. In some examples, an anti-reflective coating can be provided on the front and/or back surface of the protective outer cover 122. In some examples, as the protective outer cover 122 is located between the image-light guide 102 and the real-world objects RWO, protective outer cover 122 can provide filtering or other optical functions that affect the viewer's view of the real-world objects RWO without affecting the viewer's view of the virtual objects VO. Further, image light guide system 100 can include an optical coupler 124. Optical coupler 124 can take the form of an in-coupling diffractive optic, such as a plurality or set of surface relief gratings or a volume hologram. In some examples, optical coupler 124 can take the form of a prism configured to receive image-bearing light from projector 106 and redirect and/or in-couple the image-bearing light into image light guide 102. In some examples, optical coupler 124 includes an in-coupling diffractive optic as well as a prism.

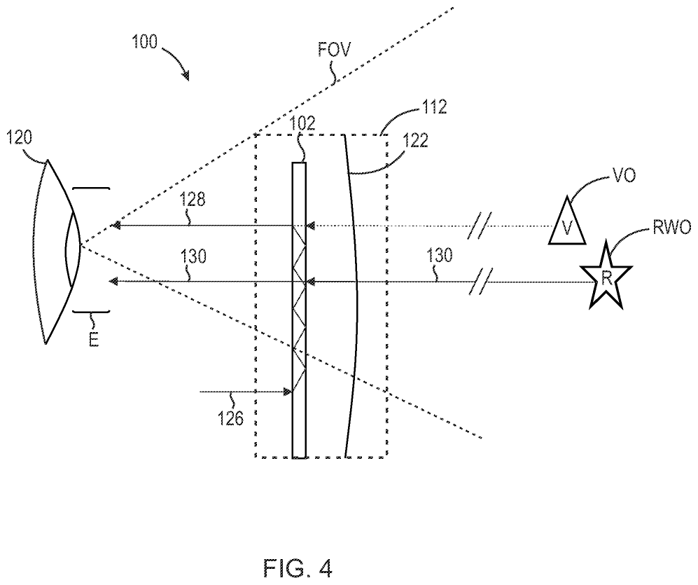

FIG. 4 illustrates a simplified schematic top plan view of one example configuration of a right-eye rim section 112 of image light guide system 100 where certain components of frame 110 have been removed for clarity. As shown, image light guide system 100 is configured to receive virtual image-bearing light 126 generated by an image source (e.g., the image source 108 shown in FIG. 3) and form images related to virtual objects VO (shown as a schematic triangle enclosing the letter “V”) in the eyebox E using at least the in-coupling, TIR, and out-coupling mechanisms of image-light guide 102 discussed above. Additionally, within a common field of view FOV, image light guide 102 is also operable to receive and transmit image-bearing light 128 reflected from real-world objects RWO (shown as a schematic star enclosing the letter “R”) to the eyebox E. As such, the viewer's right eye 120, is configured to form images associated with virtual objects VO and images associated with real-world objects RWO from within a common field of view FOV. It should be appreciated that the common field of view FOV can encompass a broader or narrower angular field of view than the field shown, e.g., the common field of view FOV could be wide enough to completely encompass the image light guide 102 or could only cover a portion of the image light guide 102. As shown in FIGS. 4-7, the dotted lines associated with virtual image-bearing light 126 (discussed below) illustrate a virtual projection associated with a virtual image originating from a virtual source position. In other words, the dotted lines illustrate virtual image-bearing light traced back to a virtual focal point within the environment such that light used to form virtual objects VO within the eyebox E appear to originate from the virtual position of the virtual object VO within the environment and within the common FOV. As shown in FIG. 4, virtual image-bearing light 126 is in-coupled into image light guide 102, propagates along the length dimension (vertically in FIG. 4) of the image light guide 102 via TIR, and is out-coupled as virtual image-bearing light 128 and is operable to form one or more images within the eyebox associated with one or more virtual objects VO from within the environment. In addition, real-world image-bearing light 130 is transmitted through image light guide 102 and proceeds to eyebox E and is operable to form one or more images within the eyebox E associated with one or more real-world objects RWO from within the environment and from within a common field of view FOV as the virtual objects VO.

As mentioned above, image source 108 is configured to produce substantially collimated virtual image-bearing light 126. In examples of image light guide system 100 where the in-coupling diffractive optic and out-coupling diffractive optic do not introduce optical power into the in-coupled virtual image-bearing light 126, the images associated with virtual objects VO formed within eyebox E will be focused at optical infinity. For some users, particularly users with certain forms of optical maladies such as myopia (near-sightedness) or astigmatism, it may not be desirable to generate images of virtual objects focused at optical infinity. Instead, it may be desirable to focus those objects a closer focusing distance, i.e., a focusing distance less than optical infinity.

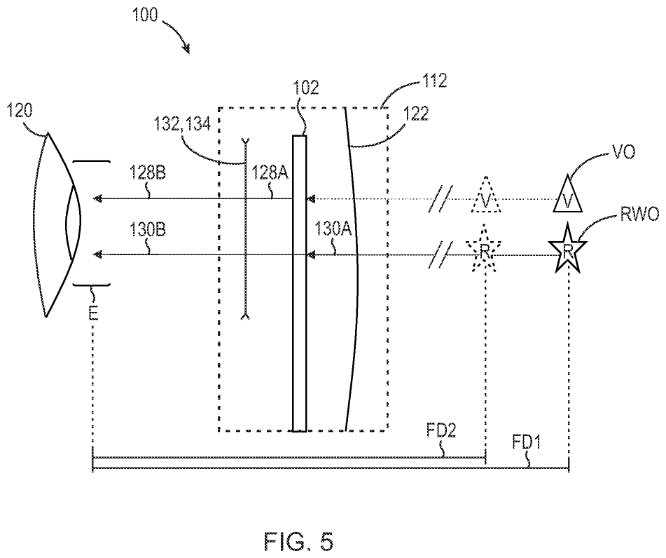

FIG. 5 illustrates a simplified schematic top plan view of one example configuration of a right-eye rim section 112 of image light guide system 100. Although not illustrated for clarity in FIGS. 5-7, it should be appreciated that virtual image-bearing light 126 may be in-coupled into image light guide 102 and can propagate by TIR along a length dimension (vertically in FIGS. 5-7) of image light guide 102 until it is out-coupled from image light guide 102 as virtual image-bearing light 128A. Additionally, although not shown in FIG. 5, it should be appreciated that virtual objects VO and real-world objects RWO are within a common field of view as show and described with respect to FIG. 4 above. As shown in FIG. 5, image light guide system 100 can also include a negative-power optical element 132 which provides a negative optical power contribution 134 to image light guide system 100. As shown, the negative-power optical element is positioned between the image light guide 102 and the viewer's right eye 120. The negative-power optical element 132 operates to diverge incident image-bearing light, reducing the apparent focusing distance of the incident image-bearing light. By positioning the negative-power optical element 132 between the image light guide and the user's eye 120, the negative-power optical element 132 operates to decrease the focusing distance for virtual objects originally focused at optical infinity. For example, the negative-power optical element 132 is configured to diverge virtual image-bearing light 128A such that the focusing distance of the virtual object VO is reduced from a first focusing distance FD1 (e.g., optical infinity) to a second focusing distance FD2 associated with virtual image-bearing light 128B, where the second focusing distance is less than the first focusing distance (e.g., less than optical infinity). Although shown schematically in FIG. 5, it should be appreciated that the negative-power optical element 132 can be formed as, without limitation, a piano-concave lens, a biconcave lens, a negative meniscus lens, or any optical element that causes incident light to diverge in predictable ways such that it forms at least one image at a reduced focusing distance from its actual distance to the viewer. In some examples, the second focusing distance FD2 is between 0.005 m and 6 m. In other examples, the second focusing distance FD2 is selected between 0.005 m and 4 m.

As a result of placing a negative-power optical element (e.g., negative-power optical element 132) between the image light guide 102 and the eyebox E, the virtual image-bearing light 128B is focused by the viewer's eye 120 such that the virtual object VO appears at a second focusing distance FD2 (shown in FIG. 5 by a triangle formed of dotted lines) where the second focusing distance FD2 is shorter than the first focusing distance FD1 with respect to the eyebox E. Additionally, as the negative-power optical element 132 is positioned between the eyebox E and the real-world objects RWO, the negative-power optical element 132 also operates to diverge real-world image-bearing light 130A such that the focusing distance of any real-world objects RWO is also reduced from, for example, a first focusing distance FD1 to a second focusing distance FD2 (shown in FIG. 5 by a star formed of dotted lines). It should be appreciated that real-world objects RWO do not need to be located at a distance greater than 6 meters (20 feet), i.e., an infinity focusing distance, to be affected by the negative optical power contribution of the negative-power optical element. For example, the perceived focusing distance of real-world objects RWO located at a finite focusing distance, e.g., between 1 and 5 meters from the viewer, will also be reduced. If the viewer desires to see the virtual objects VO at a closer focusing distance while leaving their perception of the distance to any real-world objects RWO unchanged, the negative optical power contribution 134 of the negative-power optical element 132 must be counteracted with respect to the real-world image-bearing light 130A.

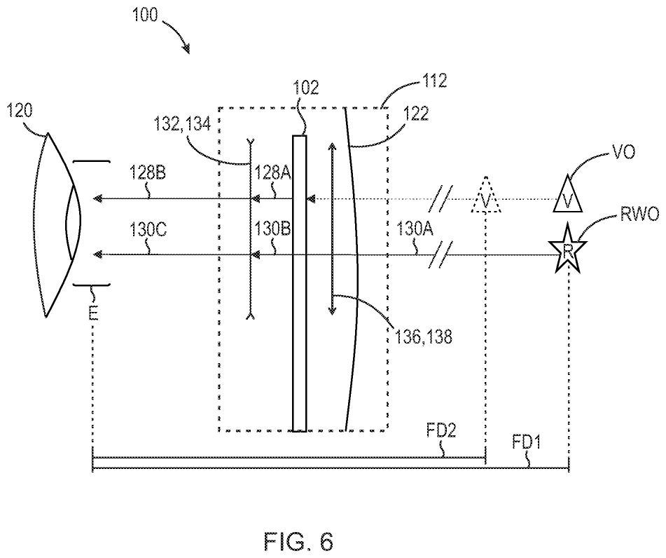

As shown in FIG. 6, which illustrates a simplified schematic top plan view of one example configuration of a right-eye rim section 112 of image light guide system 100 having both a negative-power optical element 132 and a positive-power optical element 136, where the positive-power optical element 136 provides a positive optical power contribution 138 that is configured to counteract, cancel, or negate the negative optical power contribution 134 of negative-power optical element 132 with respect to images formed from light reflected off real-world objects RWO within the environment. As shown, the positive-power optical element 136 is positioned between the image light guide 102 and the real-world objects RWO, i.e., on the opposing side of image light guide 102 with respect to the negative-power optical element 132. The positive-power optical element 136 operates to converge incident image-bearing light, increasing the apparent focusing distance of any real-world objects RWO. By positioning the positive-power optical element 136 between the image light guide 102 and the real-world objects RWO with the environment, the positive-power optical element 136 operates to increase the focusing distance for real-world objects RWO and counteract, cancel, or negate the reduction of focusing distance of images of the real-world objects RWO caused by the negative-power optical element 132, prior to the real-world image-bearing light 130A reaching the image light guide 102 and/or the negative-power optical element 132. It should be appreciated that the positive-power optical element 136 could be formed as at least a portion of the cover window 122 and/or the positive optical contribution 138 could be provided at least in part by the cover window 122.

In some examples, the negative optical power contribution 134 and positive optical power contribution 138 are measured in diopters. In these examples, the diopter value of the negative-power optical element 132 is equal to, and opposite of, the optical power provided by the positive-power optical element 134. For example, the negative optical power contribution 134 can be selected as at least one of −0.5, −0.75, −1, −1.5, −2 diopters etc. As such, to preemptively counteract the effect this negative optical power contribution 134 would have on images of real-world objects RWO, the positive optical power contribution 138 of the positive-power optical element 136 is selected to be at least one of +0.5, +0.75, +1, +1.5, +2 diopters, such that the converging effects of the positive-power optical element 136 and the diverging effects of the negative-power optical element 132 perfectly cancel to have no net effect on the real-world position of the real-world objects RWO as perceived by a viewer or other sensor positioned within the eyebox E. In other words, the net effect of providing a negative-power optical element 132 between the image light guide 102 and the eyebox E and providing a positive-power optical element 136 between the image light guide 102 and the real-world objects RWO within the environment, where the optical contributions of each optical element 132, 136 have the same magnitude and cancel each other, is that the virtual objects VO will appear at a focusing distance less than optical infinity while the focusing distance of real-world objects RWO remains unchanged.

As shown in FIG. 6, virtual image-bearing light 126 (shown in FIGS. 3 and 4) is out-coupled from image light guide 102 as substantially collimated virtual image-bearing light 128A. As virtual image-bearing light 128A refracts through negative-power optical element 132, the light diverges (shown as virtual image-bearing light 128B). Virtual image-bearing light 128B enters the eyebox E and forms an image of the virtual object VO at a second focusing distance FD2 (shown in FIG. 6 as a triangle formed of dotted lines). Additionally, real-world image-bearing light 130A, reflected off real-world objects RWO within the environment, propagates to the image light guide system 100 and encounters positive-power optical element 136, which converges real-world image-bearing light 130A forming real-world image-bearing light 130B. In this example, the positive-power optical element 136 can be formed with a positive optical power contribution of +2 diopters. Real-world image-bearing light 130B is then transmitted through image light guide 102 and encounters negative-power optical element 132 having a negative optical power contribution 134 of-2 diopters. As real-world image-bearing light 130B refracts through negative-power optical element 132, the light is diverged such that the net effect of the positive optical power contribution 138 of the positive-optical power element 136 and the negative optical power contribution 134 of the negative-optical power element 132 cancel, and real-world image-bearing light 130C is operable to form images of real-world objects RWO at their true positions within the environment.

It should be appreciated that the example described above with respect to +2 and −2 diopter values is merely one example, and that in operation image light guide system 100 can utilize any conceivable diopter setting for both the negative optical power contribution 134 and the positive optical power contribution 138. In some examples, these two diopter values cancel each other and have no net effect on the perceived focusing distance of real-world objects RWO. It should also be appreciated that although shown schematically in FIG. 6, the positive-power optical element 132 can be formed as, without limitation, a piano-convex lens, a biconvex lens, a positive meniscus lens, or any optical element that causes incident light to converge in predictable ways such that it forms at least one image at an increased focusing distance from its actual distance to the viewer.

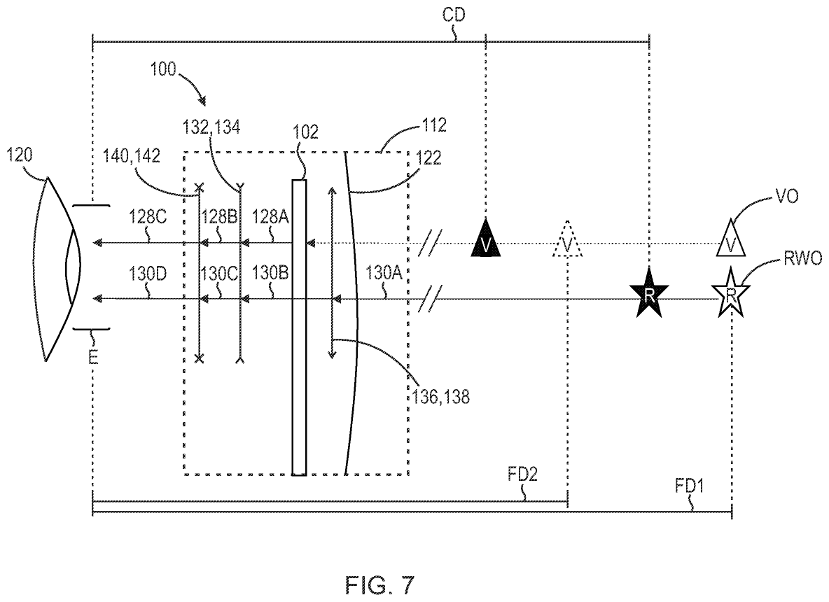

In addition to the foregoing, it may also be desirable to correct for a specific viewer's optical aberrations associated with various refractive maladies such as myopia (near-sightedness), hyperopia (far-sightedness), or astigmatism. To that end, the image light guide system 100, as shown in FIG. 7, can also include one or more corrective optical elements 140 that provide a corrective optical contribution 142 to both the virtual image-bearing light 128 and real-world image-bearing light 130. In one or more embodiments, the corrective optical element 140 can be formed as a non-variable (e.g., fixed focus) monofocal, bifocal, or multifocal optical element, such as a refractive lens, diffraction grating, holographic optical element (HOE), or any combination thereof.

As shown in FIG. 7, virtual image-bearing light 126 (shown in FIGS. 3 and 4) is out-coupled from image light guide 102 as substantially collimated virtual image-bearing light 128A. As virtual image-bearing light 128A refracts through negative-power optical element 132, the light diverges (shown as virtual image-bearing light 128B). Virtual image-bearing light 128B continues toward the eyebox E until it encounters and refracts through corrective optical element 140. Corrective optical element 140 provides a corrective optical contribution 142 which can be customized for the viewer to offset for the viewer's particular optical maladies, e.g., myopia (near-sightedness). The corrected virtual image-bearing light 128C then operates to form one or more images of virtual object VO at a corrected distance CD. In examples, where corrective optical element 140 is selected to correct for near-sightedness, corrective optical contribution 142 will provide a negative optical power, reducing the apparent distance to the virtual object VO (shown in FIG. 7 as a black triangle). It should also be appreciated that as the negative contribution of the corrective optical contribution 142 and the negative optical power contribution 134 of negative-power optical element 132 are positioned in series, the negative power is compounded, and the virtual object VO will appear at a corrected distance CD that appears closer to the viewer than the second focusing distance FD2.

Additionally, real-world image-bearing light 130A, reflected off real-world objects RWO within the environment, propagates to the image light guide system 100 and encounters positive-power optical element 136, which converges real-world image-bearing light 130A forming real-world image-bearing light 130B. In this example, the positive-power optical element 136 can be formed with a positive optical power contribution of +2 diopters. Real-world image-bearing light 130B is then transmitted through image light guide 102 and encounters negative-power optical element 132 having a negative optical power contribution 134 of −2 diopters. As real-world image-bearing light 130B refracts through negative-power optical element 132, the light is converged such that the net effect of the positive optical power contribution 138 of the positive-optical power element 136 and the negative optical power contribution 134 of the negative-optical power element 132 cancel forming real-world image-bearing light 130C, which represents the true position of the real-world object RWO within the environment. Real-world image-bearing light 130C continues to propagate in the direction of the eyebox E and encounters corrective optical element 140. Continuing with the example above where the corrective optical element 140 is selected to correct for myopia (near-sightedness), the corrective optical contribution 142 will provide a negative optical power, reducing the apparent distance to the real-world object RWO (shown in FIG. 7 as a black star). It should be appreciated that the negative power of the corrective optical element 140 operates to form images within the eyebox E of real-world objects RWO at a corrected distance CD that appears closer to the viewer than the true position of the real-world object RWO (e.g., at first focusing distance FD1).

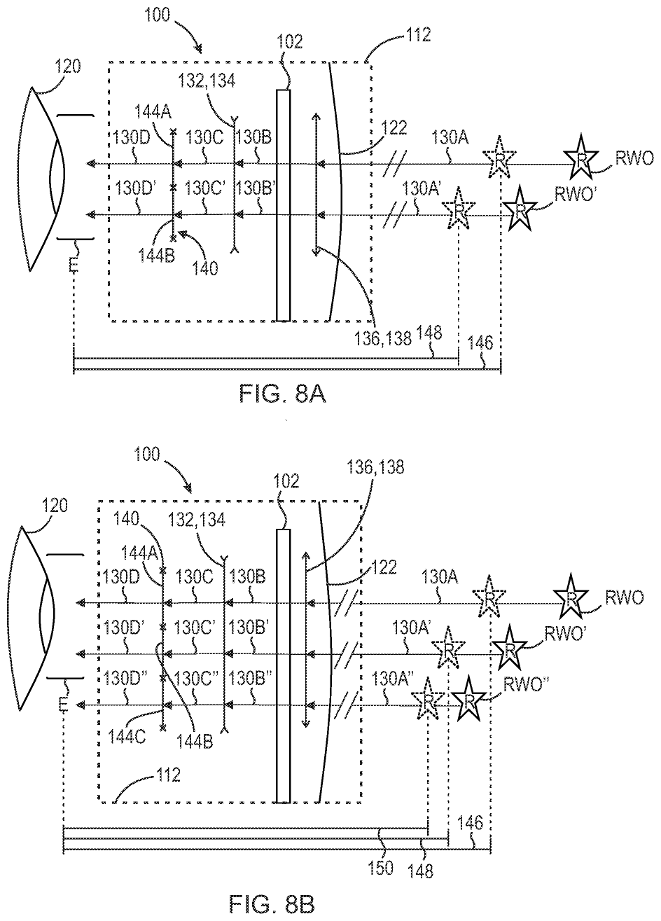

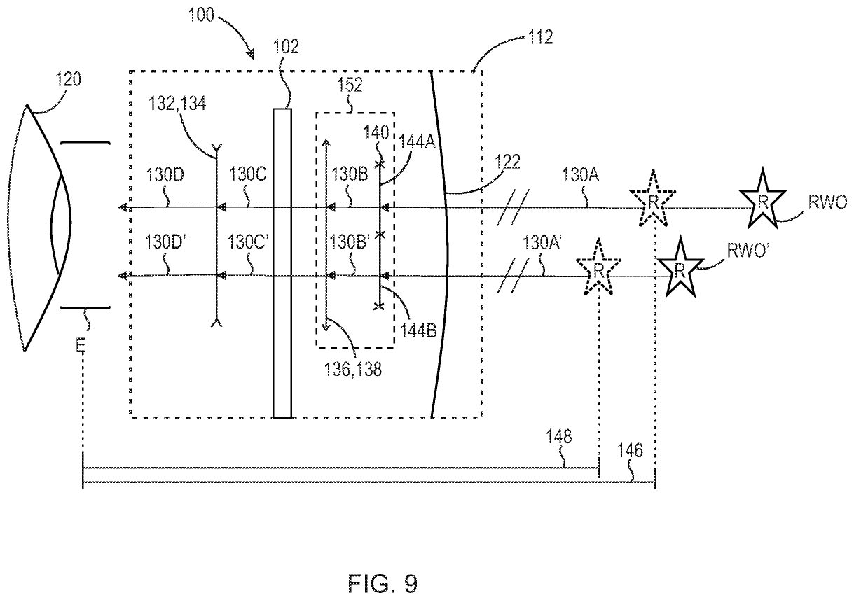

In some examples, as shown in FIGS. 8A-8B, which depict a side elevational view of image light guide system 100 according to the present disclosure, the corrective optical element 140 can be a multifocal optical element, e.g., a bifocal optical element (FIG. 8A) or a trifocal optical element (FIG. 8B). As shown in FIG. 8A, for example, image light guide system 100 can include a bifocal corrective optical element 140. As such, bifocal corrective optical element 140 is configured with a plurality of corrective sections 144A-144B. First corrective section 144A and second corrective section 144B (collectively referred to herein as “plurality of corrective sections 144” or “corrective sections 144”) are intended to be integral sections of a single corrective optical element. However, it should be appreciated that each corrective section 144 can be a discrete optical element positioned adjacent to each other as depicted in FIG. 8A.

As shown, each corrective section 144 provides a corrective optical power that is different than any adjacent corrective section such that different optical powers correctly focus images from objects at different distances, to correct for a particular viewer's optical aberrations at each distance. For example, FIG. 8A shows two real-world objects RWO, RWO′ present in the environment. The first real-world object RWO may be positioned farther away from the eyebox E than second real-world object RWO′. For example, first real-world object RWO may be positioned at a distance greater than 6 meters from the eyebox E, while second real-world object RWO′ may be positioned at a closer distance relative to the first real-world object RWO, e.g., at 3 meters from the eyebox E.

With respect to the first real-world object RWO, light reflected from that object propagates as real-world image-bearing light 130A until it reaches positive-power optical element 136 where real-world image-bearing light 130A converges to form real-world image-bearing light 130B. Real-world image-bearing light 130B continues to propagate through image light guide 102 and encounters negative-power optical element 132 where it diverges in a manner equal to and opposite of the converging effect of the positive-power optical element 136, forming real-world image-bearing light 130C. Real-world image-bearing light 130C continues to propagate in the direction of the eyebox E until it encounters first corrective section 144A of the bifocal corrective optic 140. Upon transmission through first corrective section 144A, real-world image-bearing light 130C is formed into real-world image-bearing light 130D which is used to form images of real-world object RWO that appear closer, for example, than the true position of the real-world object RWO in the environment, i.e., at a first corrected focusing distance 146. Additionally, light reflected from the second real-world object RWO′ propagates as real-world image-bearing light 130A′ until it reaches positive-power optical element 136 where real-world image-bearing light 130A′ converges to form real-world image-bearing light 130B′. Real-world image-bearing light 130B′ continues to propagate through image light guide 102 and encounters negative-power optical element 132 where it diverges in a manner equal to and opposite of the converging effect of the positive-power optical element 136, forming real-world image-bearing light 130C′. Real-world image-bearing light 130C′ continues to propagate in the direction of the eyebox E until it encounters second corrective section 144B of the bifocal corrective optic 140. Upon transmission through second corrective section 144B, real-world image-bearing light 130C′ is formed into real-world image-bearing light 130D′ which is used to form images of real-world object RWO′ that appear closer, for example, than the true position of the real-world object RWO′ in the environment, i.e., at a second corrected focusing distance 148.

Further, as shown in FIG. 8A, it should be appreciated that first corrective section 144A provides a first corrected optical power and second corrective section 144B provides a second corrected optical power where the first corrected optical power is different (e.g., greater) than the second corrected optical power. For example, should the corrective power of the bifocal corrective optical element 140 be selected to correct for myopia (near-sightedness), the change in focusing distance between the true position of real-world object RWO and the first focusing distance 146 is greater than the change in focusing distance between the true position of real-world object RWO′ and the second focusing distance 148. It should be appreciated that the optical power of each corrective section 144 could also be selected to correct for other refractive maladies, e.g., hyperopia (far-sightedness), in which case the optical power of each corrective section 144 will be selected to have less (if any) effect on objects greater than 6 meters.

FIG. 8B depicts a side elevational view of image light guide system 100 according to the present disclosure, where the corrective optical element 140 is a trifocal optical element. Real-world image-bearing light 130A-130D (associated with real-world object RWO) and real-world image-bearing light 130A′-130D′ (associated with real-world object RWO′) are similar to those described with respect to FIG. 8A. However, as shown in FIG. 8B, corrective optical element 140 includes a third corrective section 144C providing a third corrective optical power different than the first and second corrective optical powers associated with the first and second corrective sections 144A, 144B. Additionally, a third real-world object RWO″ is provided within the environment. As shown, light reflected from the third real-world object RWO″ propagates as real-world image-bearing light 130A″ until it reaches positive-power optical element 136 where real-world image-bearing light 130A″ converges to form real-world image-bearing light 130B″. Real-world image-bearing light 130B″ continues to propagate through image light guide 102 and encounters negative-power optical element 132 where it diverges in a manner equal to and opposite of the converging effect of the positive-power optical element 136, forming real-world image-bearing light 130C″. Real-world image-bearing light 130C″ continues to propagate in the direction of the eyebox E until it encounters third corrective section 144C of the trifocal corrective optic 140. Upon transmission through third corrective section 144C, real-world image-bearing light 130C″ is formed into real-world image-bearing light 130D″ which is used to form images of real-world object RWO″ that appear closer, for example, than the true position of the real-world object RWO″ in the environment, i.e., at a third corrected focusing distance 150.

FIGS. 8A-8B illustrate the effects of the multifocal corrective optical element 140 on real-world image-bearing light 130A-130D, 130A′-130D′, and 130A″-130D″ and do not illustrate the effect of the multifocal corrective optical element 140 on virtual image-bearing light 128 purely for clarity of illustration. However, it should be appreciated that the effects described above with respect to real-world image-bearing light 130B-130D, 130B′-130D′, and 130B″-130D″ can apply equally to virtual image-bearing light 128 prior to entering the eyebox E.

Referring now to FIG. 9, it should be appreciated that corrective optical element 140 can also be positioned between the image light guide 102 and the real-world objects RWO, RWO′, RWO″. For example, with respect to the first real-world object RWO, light reflected from that object propagates as real-world image-bearing light 130A until it reaches corrective optical element 140 where real-world image-bearing light 130A encounters first corrective section 144A and forms real-world image-bearing light 130B. Real-world image-bearing light 130B continues to propagate until it reaches the positive-power optical element 136 where the light converges to form real-world image-bearing light 130C. Real-world image-bearing light 130C continues to propagate through image light guide 102 and encounters negative-power optical element 132 where it diverges in a manner equal to and opposite of the converging effect of the positive-power optical element 136, forming real-world image-bearing light 130D. After transmission through the negative-power optical element 132, real-world image-bearing light 130D continues into the eyebox E and is used to form images of real-world object RWO that appear closer, for example, than the true position of the real-world object RWO in the environment, i.e., at a first corrected focusing distance 146. Additionally, light reflected from the second real-world object RWO′ propagates as real-world image-bearing light 130A′ until it reaches corrective optical element 140 where real-world image-bearing light 130A′ encounters second corrective section 144B and forms real-world image-bearing light 130B′. Real-world image-bearing light 130B′ continues to propagate until it reaches the positive-power optical element 136 where the light converges to form real-world image-bearing light 130C′. Real-world image-bearing light 130C′ continues to propagate through image light guide 102 and encounters negative-power optical element 132 where it diverges in a manner equal to and opposite of the converging effect of the positive-power optical element 136, forming real-world image-bearing light 130D′. After transmission through the negative-power optical element 132, real-world image-bearing light 130D′ continues into the eyebox E and is used to form images of real-world object RWO′ that appear closer, for example, than the true position of the real-world object RWO′ in the environment, i.e., at a second corrected focusing distance 148. As illustrated, it should be appreciated that positive power optical element 136 and corrective optical element 140 can be formed as a single multifunction optical element 152 as will be describe below.

It should be appreciated that, although shown as two or three integral corrective sections, i.e., corrective sections 144A-144C, the corrective optical element 140 can include more than three corrective sections 144. For example, corrective optical element 140 can include four, five, ten, fifteen, twenty, thirty or more corrective sections. The plurality of corrective sections 144 can seamlessly transition between corrective sections 144 where each corrective section 144 has a operates to focus images formed within the viewer's eye at different focusing distances.

With continued reference to FIG. 9, in an example embodiment, the image light guide system 100 can include at least one multifunction optical element 152 that is configured to perform the functions of one or more of the optical elements described above. For example, the positive-power optical element 136 and corrective optical element 140 are formed as a single multifunction optical element 152 arranged to perform the functions of both optical elements 136, 140 as described above. As shown, the single multifunction optical element 152 can be positioned between the image light guide 102 and the real-world object RWO, and includes the optical power contributions of both the corrective optical element 140, e.g., corrective optical contribution 142, as well as the positive optical power contribution 138 of the positive-power optical element 136.

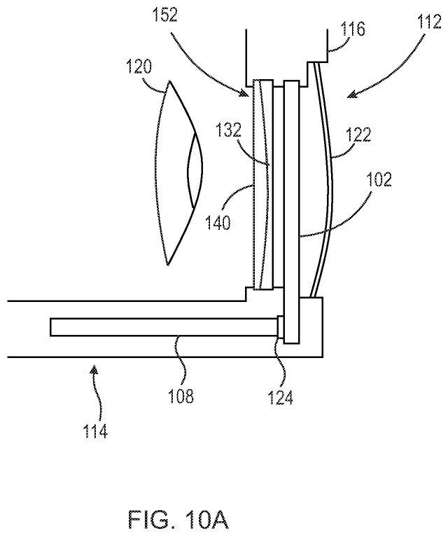

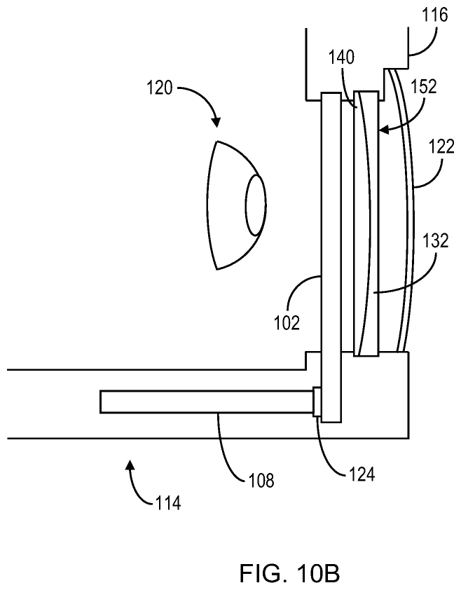

FIG. 10A shows a top plan, schematic view of a portion of an exemplary head-mounted image light guide system 100 according to the present disclosure. As shown, image light guide system 100 can include at least one multifunction optical element 152 that is configured to perform the functions of one or more of the optical elements described above. In the example shown in FIG. 10A, the negative-power optical element 132 and corrective optical element 140 are formed as a single multifunction optical element 152 arranged to perform the functions of both optical elements 132, 140 as described above. As shown, the single multifunction optical element 152 can be formed as a doublet lens, positioned between the image light guide 102 and the eyebox E, and includes the optical power contributions of both the corrective optical element 140, e.g., corrective optical contribution 142, as well as the negative optical power contribution 134 of negative-power optical element 132. Additionally, it should be appreciated that the multifunction optical element 152 can be arranged to perform the functions of the positive-power optical element 136 and the corrective optical element 140. This single multifunction optical element 152 can be formed as a doublet lens, positioned between the image light guide 102 and the real-world objects RWO, and includes the optical power contributions of both the corrective optical element 140, e.g., corrective optical contribution 142, as well as the positive optical power contribution 138 of positive-power optical element 136.

In an example embodiment, as illustrated in FIG. 10B, the image light guide system 100 includes at least one multifunction optical element 152 that is arranged to perform the functions of both the negative-power optical element 132 and the corrective optical element 140 as described above. As shown, the single multifunction optical element 152 can be formed as a doublet lens, positioned between the image light guide 102 and the real-world objects RWO, and includes the optical power contributions of both the corrective optical element 140, e.g., corrective optical contribution 142, as well as the negative optical power contribution 134 of the negative-power optical element 132. It should be appreciated that the cover window 122 is an optional element in at least one embodiment of the image light guide system 100 arranged as shown in FIGS. 10A-10B.

Additionally, as schematically depicted in FIGS. 7-9, it should be appreciated that the corrective optical element 140, the negative-power optical element 132, and the positive-power optical element 136 can be discrete optical elements separated by air or other media. For example, negative-power optical element 132 and corrective optical element 140 can be discrete lenses located between the image light guide 102 and the eyebox E as shown in FIGS. 7-8B. Alternatively, positive-power optical element 136 and corrective optical element 140 can be discrete lenses located between the image light guide 102 and the real-world objects RWO as shown in FIG. 9.

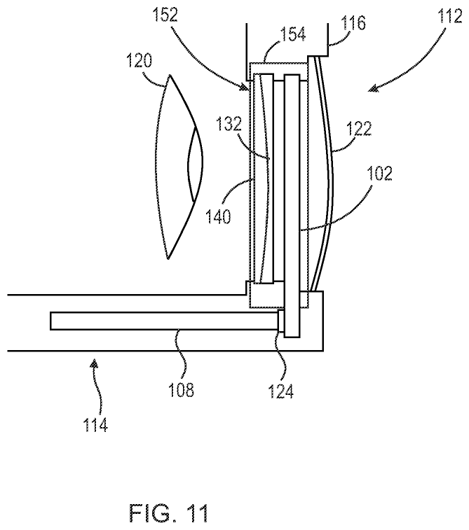

In some examples of image light guide system 100, as shown in FIG. 11, right-eye rim section 112 can further include a removable lens carrier 154 positioned between nose bridge section 116 and right temple 114 and is configured to removably engage or disengage with the right-eye rim section 112 without the aid of additional tools. Additionally, each lens described above, in each configuration described above, can be placed into, and taken out of, respective slots within the lens carrier 154, such that each lens is also removable and/or replaceable. Having the lens carrier 154 as well as the lenses themselves capable of being removed from the image light guide system 100 allows the viewer to easily customize the optical power contributions of each lens and customize the viewing experience to correct for the viewer's particular optical aberrations.

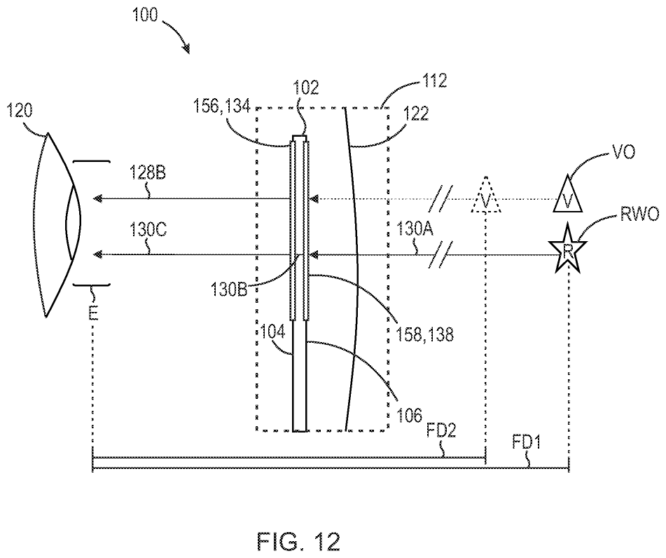

In some exemplary embodiments, as shown in FIG. 12, image light guide system 100 can include one or more electromagnetic metamaterials engaged with or embedded within one or more surfaces of the image light guide system 100. For example, metamaterials could be formed on or embedded within one or more of: (i) front surface 104 of image light guide 102; (ii) back surface 106 of image light guide 102; and (ii) either or both surfaces of the cover window or protective outer cover 122, forming one or more electromagnetic metasurfaces. As such, one or more of the optical elements within the present disclosure, e.g., negative-power optical element 132, positive-power optical element 136, or the corrective optical element 140, can be formed from an optically translucent structure, e.g., an image light guide 102, that includes one or more metamaterials configured to converge, diverge, or correct, respectively, image-bearing light passing through the optically translucent structure. It should be appreciated that the material properties of the metamaterials can be selected from any material having subwavelength structures that are configured to emulate the optical properties of a lens, e.g., a concave, convex, or other optical element, without requiring that the surface of the optical structure be curved. In other words, although the image light guide 102 and/or protective outer layer 122 disclosed in the present disclosure may include planar surfaces, a metamaterial disposed on one or more surfaces of these features may cause light rays and/or electromagnetic wavefronts associated with light passing through these features to behave as though they were passing through a shaped lens.

FIG. 12 illustrates one exemplary embodiment of a portion of image light guide system 100 including one or more metamaterials in place of lenses. In this example, rather than a lens, a linear grating structure or a holographic optical element (HOE) provide the negative optical power contribution 134, the positive optical power contribution 138, or the corrective optical power contribution 142 previously discussed. As shown in FIG. 12, in an embodiment, image light guide system 100 includes a first metamaterial 156 located on or embedded within inner surface 104 of image light guide 102 and a second metamaterial 158 located on or embedded within outer surface 106 of image light guide 102. As shown, first metamaterial 156 is configured to diverge virtual image-bearing light 128 and real-world image-bearing light 130 and is therefore operable to provide a negative optical power contribution 134. Second metamaterial 158 is configured to converge real-world image-bearing light 130 and is therefore operable to provide a positive optical power contribution 138. It should be appreciated that, similarly to other example embodiments described herein, the diopter value of the negative optical power contribution 134 and the diopter value of the positive optical power contribution 138 can be equal and opposite such that they cancel each other with respect to real-world image-bearing light 130.

In the example shown in FIG. 12, virtual image-bearing light 126 (shown in FIGS. 3 and 4) propagates within the image light guide 102 via TIR and is out-coupled from image light guide 102 as substantially collimated virtual image-bearing light. Immediately upon outcoupling from image light guide 102, virtual image-bearing light 128 engages with a first metamaterial 156 having a negative power optical contribution 134. Upon transmission through a first metamaterial 156, the light diverges (shown as virtual image-bearing light 128B) and enters the eyebox E and forms an image of the virtual object VO at a second focusing distance FD2 (shown in FIG. 12 as a triangle formed of dotted lines). Additionally, real-world image-bearing light 130A, reflected off real-world objects RWO within the environment, propagates to the image light guide system 100 and encounters the second metamaterial 158 which converges real-world image-bearing light 130A forming real-world image-bearing light 130B. In this example, the positive optical power contribution 138 of second metamaterial 158 is selected as +2 diopters. Real-world image-bearing light 130B is then transmitted through image light guide 102 and encounters the first metamaterial 156 having a negative optical power contribution 134 of −2 diopters. As real-world image-bearing light 130B refracts through the first metamaterial 156, the light is converged such that the net effect of the positive optical power contribution 138 of the second metamaterial 158 and the negative optical power contribution 134 of the first metamaterial cancel, and real-world image-bearing light 130C is operable to form images of real-world objects RWO at their true positions within the environment.

It should be appreciated that at least one of the first metamaterial 156 and the second metamaterial 158 can also include optical structures or features that operate to provide a corrective optical contribution 142. That is, it should be appreciated that either (i) the first metamaterial 156 can provide both a negative optical power contribution 134 and a corrective optical contribution 142; (ii) the second metamaterial 158 can provide both a positive optical power contribution 138 and a corrective optical contribution 142; or (iii) the first metamaterial 156 can provide both a negative optical power contribution 134 and a portion of a corrective optical contribution 142, while the second metamaterial 158 can provide both a positive optical power contribution 138 and a portion of a corrective optical contribution 142. It should also be appreciated that either or both of the first metamaterial 156 and the second metamaterial 158 can include one or more corrective sections 144A-144C as described above with respect to FIGS. 8A-8B, and as such, can provide multi-focal corrective capabilities.

It should also be appreciated that the first metamaterial 156 and/or the second metamaterial 158 can be located on or embedded within one or more surfaces of the protective outer cover 122 rather than, or in addition to, being located on or embedded within the image light guide 102. Further, it should be appreciated that the first metamaterial 156 and/or the second metamaterial 158 can be disposed on or embedded within a stand-alone optical component, e.g., a transparent or translucent planar substrate, positioned between the eyebox E and the image light guide 102 and/or between the image light guide and the real-world objects RWO.

In other examples, corrective optical element 140 can be a focus-tunable or variable-focus lens. The variable-focus lens can include a liquid lens, adaptive liquid polymer lens, or one or more liquid crystal Fresnel layers that are adaptively controllable. The variable-focus lens can be manually adjusted, e.g., via viewer interaction with a button, switch, touch-capacitive sensor, slide-switch, etc., or adjusted automatically via electronic connection to one or more controllers of image light guide system 100. As such, the controller can include a processor and non-transitory computer-readable memory configured to execute and store, respectively, a set of computer-readable instructions operable to variably alter the focus of at least a portion of the variable-focus lens. Additionally, the image light guide system 100 may further include one or more rearwardly facing sensors, e.g., one or more sensors or cameras directed toward the viewer's eyes and face, that are configured to determine the angular convergence of the viewer's eyes and automatically adjust or alter the focal distance of the variable-focus lens to provide the specific corrective optical contribution for aiding the viewer in focusing objects at a focusing distance corresponding to the angular convergence of the viewer's eyes.

The perspective view shown in FIG. 13 illustrates one example of image light guide system 100 in a display system for augmented reality viewing of virtual images. The image light guide system 100 uses one or more image light guides (e.g., image light guides 102). Image light guide system 100 is shown as a head-mounted display (HMD) with a right-eye rim section 112 having an image light guide 102R proximate the user's right eye. The image light guide system 100 includes image source 108, such as a pico-projector or similar device, energizable to generate one or more virtual images. Although not illustrated, in one example, image light guide system 100 includes a left-eye optical system including one or more image light guides and a second image source. In examples using both a right-eye rim section 112 and a left-eye rim section, the virtual images that are generated can be a stereoscopic pair of images for 3D viewing. During operation by a user or viewer, the virtual image or images formed by the image light guide system 100 can appear to be superimposed or overlaid onto the real-world scene content seen by the viewer through the right eye image light guide 102R and/or left eye image light guide. Additional components familiar to those skilled in the augmented reality visualization arts, such as one or more cameras mounted on the frame of the HMD for viewing scene content or viewer gaze tracking, can also be provided.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. An image light guide system for viewing a virtual object and a real-world object within a common field of view, comprising:
an image light guide having an inner surface and an outer surface, the image light guide arranged to direct image-bearing light beams of the virtual object toward an eyebox at a first focusing distance;
a negative-power optical element arranged between the image light guide and the eyebox, the negative-power optical element having a negative optical power contribution operable to diverge the image-bearing light beams in advance of the eyebox to a second focusing distance less than the first focusing distance;
a non-variable corrective optical element arranged between the image light guide and the real-world object, wherein the corrective optical element has a corrective optical contribution operable to reduce optical aberrations associated with viewing the real-world object at the second focusing distance; and
a positive-power optical element arranged between the image light guide and the real-world object, wherein the positive-power optical element has a positive optical power contribution operable to cancel the negative optical power contribution of the negative-power optical element without canceling or negating the corrective optical contribution of the corrective optical element.

2. The image light guide system of claim 1, wherein the positive-power optical element is formed as at least a portion of a cover window arranged between the image light guide and the real-world object.

3. The image light guide system of claim 2, wherein the cover window is arranged between the corrective optical element and the real-world object.

4. The image light guide system of claim 1, wherein the positive-power optical element and the corrective optical element are formed as a single multifunction optical element, where the single multifunction optical element is selected from (i) a lens doublet or (ii) a singular lens, and wherein the lens doublet or the singular lens provide both the negative optical power contribution and the corrective optical contribution.

5. The image light guide of system 1, wherein one or more of the negative-power optical element, the positive-power optical element, and the corrective optical element comprises a metamaterial.

6. The image light guide system of claim 1, wherein the first focusing distance is a hyperfocal to near infinite focusing distance.

7. The image light guide system of claim 1, wherein the second focusing distance is between 0.05 meters and 4 meters.

8. The image light guide system of claim 1, wherein the corrective optical element comprises a plurality of corrective sections, wherein the plurality of corrective sections include a first corrective section arranged to focus one or more real-world objects at a first corrected focusing distance and a second corrective section arranged to focus the one or more real-world objects at a second corrected focusing distance, and wherein the first corrected focusing distance and the second corrected focusing distance are different.

9. The image light guide system of claim 8, wherein the plurality of corrective sections further include a third corrective section arranged to focus the one or more real-world objects at a third focusing distance different than the first focusing distance and the second focusing distance.

10. The image light guide system of claim 9, wherein the plurality of corrective sections are arranged to progressively focus the one or more real-world objects.

11. The image light guide system of claim 1, wherein the positive-power optical element is a lens having a convex outer surface, wherein the convex outer surface is treated with a protective coating.

12. An image light guide for viewing a virtual object and a real-world object within a common field of view, comprising:
an inner surface and an outer surface, arranged to direct image-bearing light beams of the virtual object toward an eyebox at a first focusing distance;
a first metamaterial having a negative optical power contribution configured to diverge the image-bearing light beams in advance of the eyebox at a second focusing distance less than the first focusing distance; and
a second metamaterial arranged to provide a positive optical power contribution to cancel the negative optical power contribution of the first metamaterial.

13. The image light guide of claim 12, wherein at least one of the first metamaterial and the second metamaterial operates as a corrective optical element to provide a corrective optical contribution.

14. The image light guide of claim 13, wherein the corrective optical element comprises a plurality of corrective sections, wherein the plurality of corrective sections includes a first corrective section arranged to focus one or more real-world objects at a first corrected focusing distance and a second corrective section arranged to focus the one or more real-world objects at a second corrected focusing distance, where the first corrected focusing distance the second corrected focusing distance are different.

15. The image light guide of claim 12, wherein the first metamaterial is located on or is embedded within the inner surface of the image light guide.

16. The image light guide of claim 15, wherein the second metamaterial is located on or is embedded within the outer surface of the image light guide.

17. The image light guide of claim 12, wherein at least one of the first metamaterial and the second metamaterial is located on or is embedded within one or more surfaces of a cover window.

18. The image light guide of claim 12, wherein at least one of the first metamaterial and the second metamaterial comprise a linear diffractive grating.

19. The image light guide of claim 12, wherein at least one of the first metamaterial and the second metamaterial comprise a holographic optical element.
